(19) United States
(12) Patent Application Publication
(10) Pub. No.: US 2011/0032368 A1
(43) Pub. Date: Feb. 10, 2011

(54) System for Emulating Continuous Pan/Tilt Cameras

(76) Inventor: NICHOLAS JOHN PELLING, Surbiton (GB)

Correspondence Address: BAY AREA INTELLECTUAL PROPERTY GROUP, LLC, PO BOX 210459, SAN FRANCISCO, CA, 94121-0459, US

(21) Appl. No.: 12/537,845

(22) Filed: Aug. 7, 2009

(51) Int. Cl. H04N 5/232

(52) U.S. Cl. 348/211.9; 348/E05.042

(57) ABSTRACT

A system for emulating a continuous pan/tilt camera includes a camera having an image sensor for capturing an image. A camera orientation system includes a tip/tilt orientation mechanism having two axes of rotation with constrained range of movement for positioning the camera to capture the image within a hemispherical space. The two axes of rotation are generally orthogonal to each other and generally parallel to a plane forming a back side of the hemispheric space. An image transformation system rotates a portion of the captured image to emulate the continuous pan/tilt camera. The camera further includes a control system for adjusting an active area of the image sensor in response to a divergence between an optical center of the image sensor and a mechanical center of camera orientation system. The image transformation system is configurable in response to a spatial orientation of the hemispherical space.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to cameras. More particularly, the invention relates to a camera comprising constrained-range hardware orientation means combined with an image rotation post-processing stage to emulate continuous pan/tilt cameras.

### BACKGROUND OF THE INVENTION

Broadly speaking, there are two main categories of security camera: static (i.e. fixed or manually oriented) and dynamic (i.e., with powered orientation means). The present invention concerns the latter category, which in turn has two main subtypes: wall-mounted cameras, which are mounted on a vertical surface and so normally look across onto a scene, and ceiling-mounted cameras, which normally look down onto a scene from a ceiling or a high vantage point.

The construction of a wall-mounted dynamic camera is relatively straightforward. For example an exemplary wall-mounted dynamic camera may comprise camera circuitry mounted upon a chained pair of broadly orthogonally arranged rotation means, where both axes of rotation sit broadly parallel to the plane of the wall when at the central position. Both rotations need only range 90 degrees to either side of the central position to achieve a broadly hemispheric range of orientations. This mechanism is referred to herein as tip/tilt.

However, the fact that a wall-mounted camera is necessarily positioned on a wall is a significant handicap, because this placement often has a restricted or occluded view of the scene (i.e., objects are in the way), while in the context of a room, the far wall can be a long way off. Furthermore, looking across to sunlit windows and up to internal lighting can often require wide dynamic ranges of brightness to be handled at the same time.

By way of comparison, a ceiling-mounted dynamic camera, which is often covered with an inverted transparent hemispheric dome and so can be referred to as a “dome camera”, has a far better placement. This is because it has far fewer problems of occlusion, and because all walls are typically in the mid-range of vision of the camera rather than having some walls near and other walls far away. Additionally, because both the sun and ceiling-mounted lights typically illuminate downwards, ceiling-mounted cameras often have less problematic lighting conditions to deal with. However, in prior art cameras this favorable position comes at a cost.

Specifically, conventional ceiling mounted cameras typically use a pan-tilt mechanism to produce upright images; that is, images where people's bodies appear the right way up (i.e., with their heads above their legs). This pan-tilt mechanism is typically formed of two chained physical rotation means, one of which, the tilt, typically rotates up to 90 degrees to enable the camera to tilt between vertical and horizontal orientations, while the other sub-mechanism, the pan, typically rotates around the central, normally vertical, axis.

It would be very advantageous for the pan physical rotation of a camera to be unconstrained, so that the camera may travel indefinitely past 360 degrees or indefinitely backwards well before 0 degrees. However, such unconstrained rotation quickly leads to a constructional problem with the electrical connections between the camera subunit and the unit's main casing. As an unconstrained pan spins the camera subunit around, all of the electrical connections between the camera subunit and the main casing twist and tighten, ultimately causing those connections (e.g., on a ribbon cable) to twist and sometimes break as a result of the unconstrained twisting that is applied to them.

The older solution to this problem is simply to constrain rotation to proceed within a single 360-degree range, by imposing end-stops preventing rotation before and after a certain point, for example, without limitation, −180 degrees and +180 degrees. However, this has the side effect that when a camera hits either end-stop, if the user wishes to continue tracking in the same direction they must first laboriously rotate the pan all the way around to the opposite end-stop. This can take several seconds, typically around three seconds for systems built with stepper motors, and even the latest engineering solution takes about one second to do this (the “Auto-Flip” marketed by Axis Communications AB of Lund, Sweden in its Axis 215 PTZ camera, See http://www.axis.comproducts/cam_{—}215/).

Rather than impose end-stops on the pan rotation, many cameras instead pass all of the connections between the daughterboard and the main circuit board through a set of slip-rings. Though an ingenious engineering approach, this is a fragile and cumbersome solution in the context of surveillance cameras that have to be designed for physical compactness, low-cost manufacture, long-term reliability, and low maintenance.

The known prior art is silent as to the novel methods employed in preferred embodiments of the present invention. In particularly, none implements image rotation post-processing to make wall-mounted camera hardware emulate ceiling-mounted camera hardware. Moreover, known conventional approaches implement a multiplicity of cameras, imaging apparatuses and imaging methods, which is generally a less efficient approach. For example the prior art includes an omnidirectional imaging apparatus with a paraboloid reflector and sensor, a method and apparatus for inserting a high resolution image into a low resolution interactive image to produce a realistic immersive experience for dewarping a scene image and merging the image with a hi-res detail image, a motionless camera orientation system with distortion correcting sensing elements arranged to grab fisheye images linearly, an adjustable imaging system with wide angle capability that includes a pan/tilt/zoom (PTZ) camera switching between wide and narrow field views, a system for omnidirectional image viewing at a remote location without the transmission of control signals to select viewing parameters where a fisheye image is transmitted and dewarped remotely, a wide-angle dewarping method and apparatus that provides fisheye dewarping by interpolating between a set of vectors, a method for the correction of optical distortion by image processing in a wide-angle camera, multiple-view processing in wide-angle video cameras that provides distortion-correction, movement and zoom for wide-angle images, a method for automatically expanding the zoom capability of a wide-angle video camera, and face detection and tracking in a wide field of view. However, these prior art devices and methods do not include means or methods for providing the desirable aim of the unconstrained rotation in a pan/tilt camera with lower complexity than conventional pan/tilt mechanisms.

The prior art also includes a digital camera having panning and/or tilting functionality, and an image rotating device for such a camera. This device provides panning and tilting functionality by leaving the image sensor static while panning and tilting a pair of mirrors to steer the optical path onto the image sensor. The image thus captured must be rotated. The inventors of this device explicitly differentiate this solution from moving objective cameras by stating, “In prior art web cameras the panning and/or tilting functionality is obtained by moving the whole camera or at least the objective thereof.”

Although this prior art device uses mirrors that pan and tilt, the mirrors themselves are oblivious to their orientation, and so the panning and tilting mirrors are actually emulating not a pan/tilt camera but a tip/tilt camera, which is why the camera requires a subsequent image rotation twist stage in order for the device to work. Effectively, then, it could be said that the device uses panning and tilting mirrors to emulate a tip/tilt camera, in combination with a subsequent image rotation twist stage to make the images thus captured into their pan/tilt equivalent. However, the particular focus of the inventors is the “inventive image rotation device”, by which they specifically mean the arrangement of mirrors. The subsequent image processing rotation stage they sensibly describe as “well within reach of a man skilled in the art of digital cameras”. However, even though this device provides unconstrained rotation for the mirrors, the mirrors add to the complexity of the orientation means rather than simplifying the orientation means.

In view of the foregoing, there is a need for improved techniques for achieving the desirable aim of unconstrained rotation in a pan/tilt camera. Specifically, what is desired is a mechanism with lower physical complexity than the conventional pan/tilt mechanism, preferably of the order of complexity of tip/tilt mechanisms used in wall-mounted cameras, and very preferably with the removal of slip-rings. What is also desired is a solution with a software image processing aspect, to make use of the new generation of powerful yet low-cost media processor components as often used in mobile camera-phones.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary ceiling mounted tip/tilt/twist camera, in accordance with an embodiment of the present invention;

FIG. 2 is a flow chart illustrating an exemplary process performed by a software aspect of a tip/tilt/twist camera, according to an embodiment of the present invention;

FIG. 3 illustrates an exemplary method for rotating an image and for windowing a sensor to correct the disparity between the optical center and the sensor center of a tip/tilt/twist camera, in accordance with an embodiment of the present invention;

FIGS. 4A, 4B, 4C, and 4D illustrate various exemplary configurations of a daughterboard with an image sensor and a lens, constrained-range orientation means and image rotation circuitry of a tip/tilt/twist camera, in accordance with embodiments of the present invention; and

FIG. 5 illustrates a typical computer system that, when appropriately configured or designed, can serve as a computer system in which the invention may be embodied

Unless otherwise indicated illustrations in the figures are not necessarily drawn to scale.

### SUMMARY OF THE INVENTION

To achieve the forgoing and other objects and in accordance with the purpose of the invention, a system for emulating a continuous pan/tilt camera is presented.

In one embodiment a system for emulating a continuous pan/tilt camera is presented. The system includes means for capturing an image, means for orientating the capturing means to capture the image within a hemispherical space and means for rotating the captured image to emulate the continuous pan/tilt camera. In another embodiment the means for orientating further includes a tip/tilt orientation mechanism. Yet another embodiment further includes means for adjusting the capturing means in response to a divergence between an optical center and a mechanical center of orienting means. Still another embodiment further includes means for configuring the rotating means in response to a spatial orientation of the hemispherical space. Another embodiments further include means for transmitting the image and rotation information to the rotating means, means for compressing the image before transmitting to the rotating means and means for reducing a size of the compressed image.

In another embodiment a system for emulating a continuous pan/tilt camera is presented. The system includes a camera including an image sensor for capturing an image. A camera orientation system includes a constrained range of movement for positioning the camera to capture the image within a hemispherical space. An image transformation system rotates a portion of the captured image to emulate the continuous pan/tilt camera. In another embodiment the camera orientation system further includes a tip/tilt orientation mechanism having two axes of rotation, where the two axes of rotation are generally orthogonal to each other and generally parallel to a plane forming a back side of the hemispheric space. In yet another embodiment the camera further includes a control system for adjusting an active area of the image sensor in response to a divergence between an optical center of the image sensor and a mechanical center of camera orientation system. In still another embodiment at least the image transformation system is configurable in response to a spatial orientation of the hemispherical space. In various other embodiments the camera transmits the image and rotation information to the image transformation system, the camera compresses the image before transmitting to the image transformation system and pixels outside a desired rotated image space are processed to reduce a size of the compressed image.

In another embodiment a system for emulating a continuous pan/tilt camera is presented. The system includes a camera including an optical imaging system and an image sensor for capturing an image. A camera orientation system includes a tip/tilt orientation mechanism having two axes of rotation with constrained range of movement for positioning the camera to capture the image within a hemispherical space. The two axes of rotation are generally orthogonal to each other and generally parallel to a plane forming a back side of the hemispheric space. An image transformation system rotates a portion of the captured image to emulate the continuous pan/tilt camera. The camera transmits the captured image to the transformation system. In another embodiment the camera further includes a control system for adjusting an active area of the image sensor in response to a divergence between an optical center of the image sensor and a mechanical center of camera orientation system. In yet another embodiment at least the image transformation system is configurable in response to a spatial orientation of the hemispherical space. In still other embodiments the camera transmits the image and rotation information to the image transformation system, the camera compresses the image before transmitting to the image transformation system and pixels outside a desired rotated image space are processed to reduce a size of the compressed image.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. In addition, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

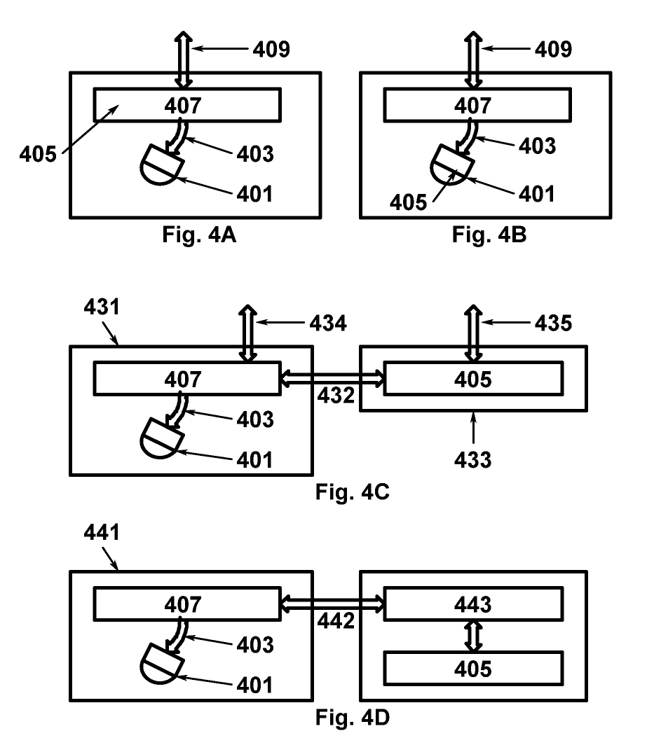

Preferred embodiments of the present invention combine a camera mounted on constrained-range orientation hardware with a subsequent image rotation post-processing stage so as to be able to emulate continuous pan/tilt cameras. Those skilled in the art, in light of the present teachings, will readily recognize that there are a multiplicity of suitable configurations for the elements of such a camera, including, without limitation, the four basic design variants depicted by way of example in FIGS. 4A, 4B, 4C, and 4D. Preferred embodiments use tip/tilt orientation mechanisms (i.e., two chained constrained rotations with both axes of rotation broadly in the plane of the mounting plate when in the central position) as a specific type of constrained-range orientation hardware. However, in alternate embodiments, other types of constrained-range orientation hardware may be suitable, such as, but not limited to, what are normally referred to as robotic “wrists”, Gosselin's Agile Eye, Gosselin's Simplified Agile Eye, and Weimin Li's HEMISPHERE.

One preferred embodiment of the present invention uses a simple tip/tilt orientation mechanism in combination with a configuration wherein image rotation means is placed on a daughterboard along with an image sensor and lens, for example, without limitation, the configuration shown by way of example in FIG. 4B. However, a multiplicity of suitable configurations of the elements may be used in various alternate embodiments. A non-limiting specific implementation example of this embodiment comprises the CW5631 visual signal processor produced by Chipwrights, Inc, which is fully capable of accepting commands over a serial connection, controlling an image sensor, capturing images from the sensor, suitably rotating these images to emulate an upright image, and outputting the images in the form of a composite video output.

In preferred embodiments, a main circuit board both powers and communicates with a daughterboard over a short cable and uses its own simple microcontroller to drive the constrained tip/tilt orientation means. This microcontroller provides a suitable control interface to the outside world, such as, but not limited to, the widely used RS485, RS422, RS232, USB, HomePlug, Ethernet, Wi-Fi, Bluetooth, and IrDA standards and sends commands received over this interface to the daughterboard over a serial connection.

In preferred embodiments comprising a network video recorder, for example, without limitation, the embodiment shown by way of example in FIG. 4D, a relevance mask of constant or variable shape is applied to captured non-rotated images prior to compression so as to reduce the size of the compressed images transmitted to the network video recorder.

Preferred embodiments of the present invention provide ceiling-mounted cameras by combining a camera mounted upon a constrained physical orientation mechanism, such as, but not limited to, the type of tip/tilt mechanisms used by wall-mounted cameras, with an image post-processing mechanism to rotate the image captured by the camera. A simple embodiment of the present invention can therefore be usefully thought of as using a combination of two constrained hardware rotations (i.e., tip/tilt) followed by an unconstrained software rotation (i.e., twist), so as to simulate the combination of an unconstrained hardware rotation (i.e., pan) and a constrained hardware rotation (i.e., tilt). This can be viewed as achieving the effect of a pan/tilt orientation mechanism by using low-complexity hardware to point the camera in the correct direction, and then using image rotation means to rotate the image captured such that the image becomes an upright image similar to that which would have been captured by a continuous pan/tilt camera pointing in the same direction. Some embodiments may also comprise the ability to switch between mathematical transformations in the controlling software to produce a camera that may be mounted practically anywhere for example, without limitation, on a wall, a table, a floor, etc.

To achieve the correct image rotation, what is required is knowledge of the location on the sensor through which the optical axis passes and of the final difference in mathematical transformations between an idealized version of an unconstrained orienting mechanism, such as, but not limited to, pan/tilt, and the constrained orienting mechanism chosen to replace the unconstrained orienting mechanism, such as, but not limited to, tip/tilt. This rotational difference (i.e., the twist) between the two frames of reference forms the parameter used for the image rotation around the optical center of the sensor. Non-analytically, if two orientation mechanisms are able to point in the same direction, all that should be required is to calculate the rotational difference (i.e., the twist) between the two transformations sufficient to map one to the other as a post-processing stage. Preferred embodiments also use sensor windowing to help correct for the almost-inevitable disparity between optical center as intended and optical center as constructed.

Note that the preceding should not be read as implying that tip/tilt is the only possible orientation mechanism. One important aspect of preferred embodiments of the present invention is that any constrained broadly hemispheric orientation mechanism (i.e., not just tip/tilt) can be combined with an image rotation post-processing stage to emulate a pan/tilt camera, for example, without limitation, the extensive robotic “wrists” academic and patent literature, from which I particularly note Gosselin's Agile Eye, Gosselin's Simplified Agile Eye, and Professor Weimin Li's HEMISPHERE. This allows many other solutions to the same problem to be engineered with different features such as, but not limited to, high reliability, low cost, high precision, high speed, etc. As long as the replacement orientation mechanism is able to reasonably match the range of directions selectable by comparable pan/tilt solutions and the orientation of the replacement mechanism is sufficiently predictable or knowable, a correctional rotation parameter (i.e., the twist value) can be reliably generated and applied to the captured image in order to rotate the final captured image into position.

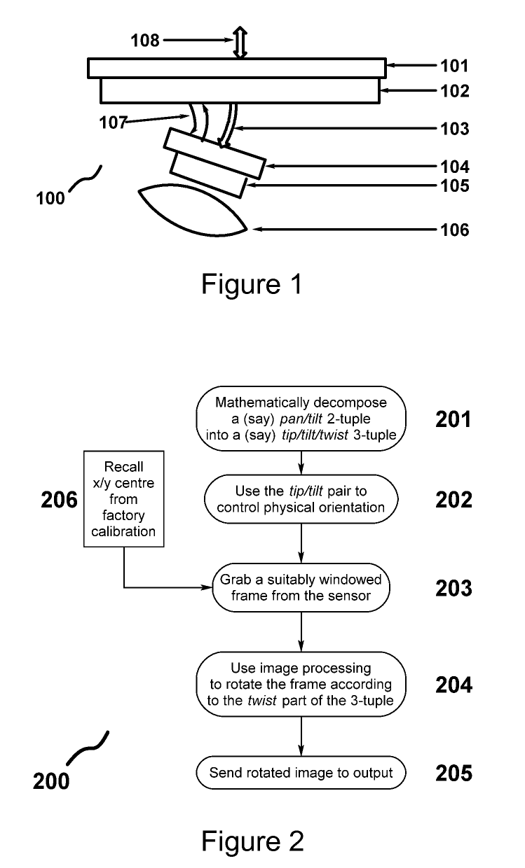

FIG. 1 illustrates an exemplary ceiling mounted tip/tilt/twist camera 100, in accordance with an embodiment of the present invention. The physical composition of the system will be recognizable to those skilled in the arts of designing and building dynamic wall-mounted cameras; however, the present embodiment comprises extended control electronics circuitry to enable image rotation on a captured image. The specific nature of the means by which the image rotation is performed is immaterial to the present embodiment. Exemplary image rotation means that may be suitable in the present embodiment include, without limitation, 2-pass image rotation algorithms, Alan Paeth's 3-shear image rotation algorithm, cubic B-spline, cubic OMOMS, Kirshner's Sobolev image rotation algorithm, as well as hundreds of others in the academic and patent literature. It should also be noted that image rotation processes can also usefully be constructed to act upon the kind of raw images emitted by image sensors, for example where the individual pixels are filtered using one of the well-known Bayer colour filter array patterns.

In the present embodiment, the base component of camera 100 is a mounting plate 101 to be fastened to a suitable surface such as, but not limited to, a ceiling. However, it is important to note that the system described may be configured to be ceiling-mounted, wall-mounted, table-mounted, or even mounted at an angle, simply by changing the desired mathematical transform within the controlling software. Upon mounting plate 101 is attached a primary circuit board 102, which is connected to the outside world by a set of power and communication interfaces 108, which may comprise wired physical connections such as, but not limited to, composite video, RS485, RS422, Ethernet, HomePlug, etc. or non-wired physical connections such as, but not limited to, wireless, WiFi, Bluetooth, infrared, etc. Mounted on primary circuit board 102 is a broadly hemispheric, constrained-range, simple orientation mechanism 103 such as, but not limited to, a tip/tilt mechanism. A secondary daughterboard 104 is mounted onto orientation mechanism 103, upon which is mounted an image sensor 105 and an optical imaging system 106 such as, but not limited to, a lens, a set of lens elements, a zoom lens, a distortion or compression lens, planar mirrors, convex mirrors, concave mirrors, holographic optics, diffractive optics, and so forth. Optical imaging system 106 selects, directs, and concentrates light upon image sensor 105. Control lines 107 between primary circuit board 102 and daughterboard 104 operate functions such as, but not limited to, power, control, video data, etc. Constrained-range orientation mechanism 103 and image sensor 105 are configured and controlled by electronics in both primary circuit board 102 and daughterboard 104 as appropriate to the design. However, a typical design constraint on actual systems would be to minimize the combined weight of daughterboard 104, image sensor 105, and optical imaging system 106 so as to reduce the total load that orientation mechanism 103 must rotate into the desired direction.

FIG. 2 is a flow chart illustrating an exemplary process performed by a software aspect of a tip/tilt/twist camera, according to an embodiment of the present invention. Initially in step 201, the camera takes a desired orientation, for example, without limitation, a pan/tilt 2-tuple, and converts this orientation to another orientation, for example, without limitation, a tip/tilt/twist 3-tuple. In this case, the tip/tilt pair is then used to control the physical orientation of the camera in step 202. Using the x/y center of the sensor obtained during factory calibration as recalled in step 206, a suitably windowed frame is then grabbed from the sensor of the camera in step 203, which is then image rotated according to the twist portion of the tip/tilt/twist 3-tuple in step 204. Finally, the correctly rotated image is sent to the appropriate output in step 205. If appropriate, the factory calibration step 206 can be omitted by capturing a constant windowed frame from the sensor, though this will reduce the accuracy of the overall system. As is described elsewhere here, the overall camera system can be designed to execute the required image rotation 203 using many different algorithms and many different means, some of which can be external to the camera itself. Hence, the flow-chart depicted in FIG. 2 should be interpreted not as a description of control-flow within a single camera, but rather as a description of data-flow through one or more devices. For example, the image rotation stage 204 may usefully be performed on a camera, or an external image processing server, a network video recorder, a personal computer, a personal computer's graphics card, a personal media player, or a mobile phone. Further, if a particular image is not required to be viewed 205, there may be no need for any image rotation 204 to be performed at all on that image.

It will be appreciated by those skilled in the art, in light of the present teachings, that an image sensor that is slightly larger than the desired output image is typically needed in order to capture rotated images at the same sampling frequency without introducing clipped areas at the corners of the image when rotated to the desired orientation. For example, without limitation, although a non-rotated 640×480 VGA image may be reliably captured on a 640×480 sensor, an 800×800 area on a sensor, as 800 pixels is the length of the diagonal on a 640 pixel×480 pixel rectangle with a 1:1 aspect ratio is preferably used in order for an image rotation to be successfully performed without clipping and with the same sampling frequency. All the same, the sensor resolution to be chosen is a matter more for commercial preference and market needs than particularly for technical requirements. In some implementations, the clipping of the corners of the image may not be an issue, and in these implementations, the image sensor may not be larger than the desired output image.

Moreover, there is a particular issue concerning alignment. Because of the manufacturing tolerances involved in mounting the lens on the sensor, in mounting the sensor on the daughterboard and in mounting the daughterboard on the orientation means in typical cameras, the optical center for rotation may well differ from the mechanical center between different cameras as constructed. For example, without limitation, though the pixels on a modern image sensor may have dimensions of around 3 um×3 um, which would yield a 2.4 mm×2.4 mm square for an 800×800 pixel window, the cumulative positioning error from all the stages combined may amount to as much as 1 mm. In a conventional wall-mounted camera, such a disparity would have little consequence; however, the presence in preferred embodiments of the present invention of an additional image processing stage means that this disparity should be compensated for, if the final image is not to end up erroneously placed.

What the camera therefore requires is additional means to assess the difference between the mechanical center of the orientation means and the optical center of the sensor. Though intended to be very similar, manufacturing tolerances very likely prevent a practically perfect match from being achieved. In practice, there is also uncertainty about the relationship between the parameters used for driving the orientation means and the actual orientation achieved, and factors such as, but not limited to, thermal expansion of components may introduce yet further uncertainty.

Trying to compensate for every type of uncertainty in a system would likely lead to a heavily over-engineered solution with limited applicability. What is instead proposed here by way of example in the present embodiment is an appropriate method of managing the cumulative divergence between the optical center and the mechanical center, which divergence is often introduced during the manufacturing process in many practical applications. However, in some embodiments, where other factors such as, but not limited to, affordability and speed are more important than image quality, the following method for compensating for this disparity may not be performed.

Generally, a factory calibration process may be designed whereby the actual optical frame of reference of the daughterboard is initially determined at the central position of the optical frame. This frame of reference typically is the x/y coordinates of the image sensor. This information is then stored within the final camera. Then, during camera operation, the camera system makes use of an image sensor configuration technique referred to as windowing, whereby an image sensor can be configured to use an active rectangular window smaller than the actual dimensions of the image sensor. As a consequence, this ability to move a window around relies on the image sensor's pixel dimensions being slightly larger than the minimum technical requirement would otherwise require. In the present case, the x/y coordinate pair determined in the factory calibration is then used to offset the smaller window within the larger image sensor plane so as to correct for the measured divergence. The size difference between the windowed rectangle and the sensor rectangle determines how much divergence can be accommodated.

For example, without limitation, if a process that requires an 800×800 pixel rectangle is to be windowed within a 1280×1024 pixel rectangle on a 5.76 mm×4.29 mm sensor, the process allows up to 480 pixels (i.e., 1280−800) of divergence to be handled in the longer dimension (i.e., roughly −1.08 mm to +1.08 mm), and up to 224 pixels (i.e., 1024−800) of divergence to be handled in the shorter dimension (i.e., roughly −0.47 mm to +0.47 mm). In alternate embodiments where it is necessary for this process to handle greater divergences than these, a higher resolution and/or larger format sensor is used.

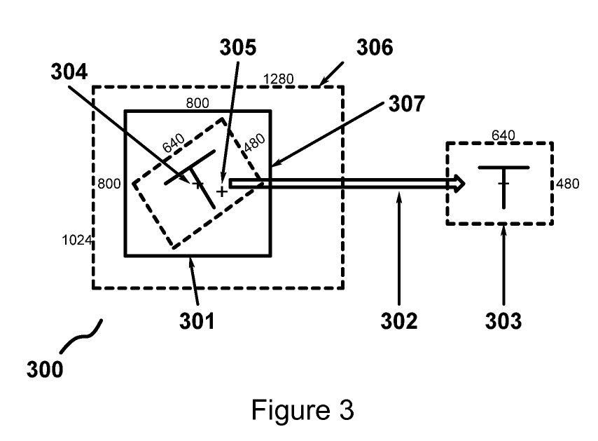

FIG. 3 illustrates an exemplary method for rotating an image and for windowing a sensor to correct the disparity between an optical center 304 and a mechanical sensor center 305 of a tip/tilt/twist camera, in accordance with an embodiment of the present invention. The image rotation portion of the process should be familiar to those with ordinary skill in image processing, and may be accomplished in many different ways, such as, but not limited to, as a hardware implementation, software calls to an OpenGL driver, a software implementation, etc. In each case, a portion of an intermediate image 301 captured by the image sensor from within a sensor rectangle 306 is rotated by an appropriate image rotation means 302 to form an output image 303. This is performed internally to the camera system as a whole. In the present embodiment, intermediate image 301 has a VGA resolution of 800×800 pixels, sensor rectangle 306 has a VGA resolution of 1024×1280 pixels, and output image 303 has a VGA resolution of 640×480 pixels. However, the sensor rectangle, intermediate image and output image may vary in resolution in alternate embodiments. What can also be seen in FIG. 3 is how optical center 304 has diverged from mechanical sensor center 305. In the present embodiment, a sensor window 307, corresponding to intermediate image 301, has been suitably adjusted within the overall area of sensor rectangle 306 to compensate for this divergence by being centered on optical center 304 rather than mechanical sensor center 305.

In the context of the kind of camera described here, it should be clear to those skilled in the art that there is a trade-off to be made between high pixel-count sensors, which enable significant windowing to be used but cost more and typically have lower light sensitivity, and low-pixel count sensors, which enable less windowing to be used but cost less and have higher light sensitivity. Given that we are particularly interested in capturing a square-shaped image windowed within a rectangular sensor, we will always have one axis with significantly more spare resolution than the other axis. One proposal here, then, is that the physical mounting structure between the sensor and the optics should be designed in such a way as to broadly align the direction of the physical ‘slack’ with the longer axis of the rectangular sensor.

It should be appreciated that the ability to mimic complex orientation styles such as, but not limited to, continuous pan/tilt or tilt/pan in preferred embodiments provides the camera the ability of being able to be wall-mounted, ceiling-mounted, table-mounted, etc. by switching the controlling software so that the camera emulates a horizontally mounted camera, a vertically mounted camera and/or a camera mounted at an angle. This enables the camera, with the addition of suitable switching software to select between different coordinate transformations, to function as a mount-it-anywhere camera solution.

Finally, it should be noted that the invention is flexible enough to find use in many different markets such as, but not limited to, surveillance and monitoring, industrial inspection, television and film markets, medical, automotive security, automotive vision, robotics, aerial reconnaissance, remote sensing, webcams, teleconferencing, etc. Yet even within the security market, different industries, countries, regions, markets and individual users have radically different use needs, technical needs and preferences. It should therefore be appreciated that a single design would be highly unlikely to meet every requirement, and a multiplicity of alternate embodiments may be configured to meet individual needs and preferences.

Therefore, the following describes a number of different design variants or exemplary alternate embodiments. These alternate embodiments differ from each other largely in terms of where the image circuitry to perform the image rotation is located. FIGS. 4A, 4B, 4C, and 4D illustrate various exemplary configurations of a daughterboard 401 with an image sensor and a lens, constrained-range orientation means 403 and image rotation means 405 of a tip/tilt/twist camera, in accordance with embodiments of the present invention.

In the embodiments shown by way of example in FIGS. 4A and 4B, the image rotation is performed on a main circuit board 407 or on daughterboard 401, each of which has specific advantages and disadvantages to be considered when engineering cameras to suit the needs of different markets. In both of these embodiments, the image rotation is performed within the camera itself. Referring to FIG. 4A, image rotation means 405 in the present embodiment is located in main circuit board 407, which has the benefit of lowering the weight of the circuitry on daughterboard 401, and so easing the load that constrained-range orientation means 403 must move. Communication interface 409 enables main circuit board 407 to communicate with the outside world. Communication interface 409 may comprise various types of communication means including, without limitation, composite video, RS485, RS422, RS232, Ethernet, HomePlug, Wi-Fi, Bluetooth, IrDA, etc.

Alternatively, referring to FIG. 4B, image rotation means 405 in the present embodiment is located on daughterboard 401, which has the benefit of simplifying the electrical interface between main circuit board 407 and daughterboard 401 as a result of the less complex signals to be transferred between the two. A simplified electrical interface between main circuit board 407 and daughterboard 401 means less connections that may be twisted or damaged with the movement of constrained-range orientation means 403. As in the previously described embodiment, main circuit board 407 in the present embodiment communicates with the outside world through communication means 409.

Referring to FIG. 4C, by way of comparison, a third embodiment expresses the idea of “breaking out” the post-processing rotation stage into a separate unit. This may be beneficial for various reasons. For example, without limitation, the separate post-processing unit may be independently sold as a unit for converting dynamic wall-mounted cameras into ceiling-mounted units, or separating the post-processing unit from the camera may enable the camera to be smaller. In the present embodiment, rotation means 405 and orientation transformation means are embodied in an external box 433 connected to a constrained-range wall-mount-style camera 431. One or both of the two, camera 431 and external box 433, suitably communicates with the outside world with communication means 434 and 435, respectively, so as to convert the stream of images sent by constrained-range camera 431, for example, without limitation, a dynamic USB webcam, over a connecting interface 432, such as, but not limited to, Ethernet, USB cabling, or wireless means, into a stream of images that are broadly equivalent to those that would have been captured by a continuous pan/tilt camera in the same location. Communication means 434 and 435 may include, without limitation, composite video, RS485, RS422, RS232, Ethernet, HomePlug, wireless means, Bluetooth, IrDA, etc. Also in this third configuration, both constrained-range camera 431 and external image rotation means 405 may be considered as a single camera system for the purposes of this description.

Referring to FIG. 4D, a fourth embodiment expresses the idea of deferring the image rotation stage into, for example, a network video recorder 443. The preferred way of implementing this is for a camera subunit 441 to send or embed an additional metadata stream detailing how to transform the picture-as-captured into the upright-picture-as-desired. This allows the camera itself to be cost-reduced, by deferring the complex image processing downstream to the network video recorder or to the operator's viewing means, whether this happens to be a personal computer or a mobile phone. This gives operators and system designers the freedom to decide how best and when best to rotate the captured image. However, alternate methods for implementing the post-processing image rotation may be suitable in alternate embodiments, such as, but not limited to, devices connected to the outputs of one or more cameras which would capable of decompressing the stream, rotating the images according to the metadata, and recompressing the stream; or computer or computers to which the network video recorder is attached or will subsequently be attached. In the present embodiment, constrained-range dynamic camera 441 sends images across a communications medium 442, such as, but not limited to, Ethernet, USB cabling, RS485, wireless communication means, etc. to network video recorder 443 within which image rotation means 405 is embodied. The image rotation process could then be performed by network video recorder 443 on receipt or when later requested, transforming the unrotated image stream captured by dynamic camera 441 into the kind of upright image stream as produced by a comparable continuous pan/tilt cameras. Also in the present embodiment, both constrained-range camera 441 and external image rotation means 405 embedded in network video recorder 443 or on an operator's personal computer or mobile phone may specifically be considered as a single camera system for the purposes of this description.

Those skilled in the art, in light of the present teachings, will readily recognize that a multiplicity of suitable configurations of elements may be implemented in alternate embodiments. For example, without limitation, in another exemplary embodiment, multiple cameras in an installation may be connected to a single rotation unit which is able to decompress, rotate according to the metadata, and then recompress the images being streamed from the cameras before passing them all on to a network video recorder. To simplify the overall system installation requirements, such a device may also be connected to the cameras by a different protocol such as RS485, HomePlug or Bluetooth, where the compressed video output stream is sent forward to the network video recorder.

It should be understood that, because of the compactness of dynamic cameras produced in accordance with the embodiments described here, the cameras may easily be integrated, often multiple times, into compound units comprising, for example, without limitation, additional sensors, devices, functionality, connections, and control features. This description should be clearly understood to cover the use of this device both as a simple unit and expressed as a component of a more complex unit.

It should be appreciated that image rotation is not a perfect process, and that it involves manipulating a source image via techniques such as, but not limited to, sampling and filtering to produce an approximation of the image that would have been seen had the camera been rotated by a particular angle. The fact that a rotated image is an approximation may be unacceptable in some markets, or the amount of computational bandwidth required to produce a good approximation on an embedded camera may involve a level of cost some markets may not be able to bear. Furthermore, though a rotated image may be visually acceptable, the complex signal processing involved may still introduce a certain amount of noise.

In these cases, an embodiment with a network video recorder, for example, without limitation, the embodiment shown by way of example in FIG. 4D may be most appropriate, where the image rotation means is not on the camera subunit but is instead embodied as part of the network video recorder. However, this process may require a larger image to be captured on the camera subunit and transferred across a communication medium such as, but not limited to, an Ethernet cable or USB cable, and thus may require roughly twice the bandwidth to carry a full non-rotated image circle across that communication medium to the network video recorder than would be required to carry a smaller image sent by a conventional pan/tilt camera. For example, the number of pixels in an 800×800 image is a little over twice the number of pixels in a 640×480 image.

Furthermore, network video recorders are typically optimized for streaming compressed data from multiple cameras directly onto one or more hard drives, and would find very challenging the process of decompressing, sampling and rotating, and recompressing images as the images are sent. However, if these incoming images are twice as large as they need be, and network video recorders prefer to send the images straight to storage devices, the obvious alternative would be for the network video recorders to store twice as much data as they need to, which is typically not desirable.

This problem in many practical applications may be generalized as follows. In a number of contexts, it is preferable to avoid rotating the source images before they are stored, yet transmitting and storing a whole non-rotated frame on a network video recorder is undesirable, while it is also desirable to use low complexity hardware to implement the camera subunit. All of which motivates the following exemplary solution. First, note that typical still image compression formats, such as, but not limited to, JPEG, compress blank areas many times more efficiently than areas comprising content. Secondly, note that typical motion image compression formats, such as, but not limited to, MPEG, compress unchanging areas many times more efficiently than areas containing moving content. Then, given that the images and streams transferred across the communication medium between the camera subunit and the network video recorder are expected to be compressed using such techniques, a good solution for still image compression would be for the camera subunit to blank out a large amount of the unused image before the image is compressed, while for motion compression, a related solution might be to leave unused data unchanged. The issue then becomes how to design a “relevance mask”, a function determining which pixels are required and which pixels to treat differently, for example by blanking or leaving unchanged. The simplest such mask would be a circular template, where the diameter of the circle broadly corresponded to the diagonal length of the rotated image, which would directly reduce the number of contentful pixels by more than 20%. To reduce the number of active pixels to compress by closer to 50%, a more optimal solution would be to use the shape of the rotated rectangle as a mask. However, this is not acceptable in most cases, because typical image rotation algorithms make use of the neighbourhood of pixels when interpolating the central pixel at a desired position. Therefore, to avoid introducing unwanted secondary effects around the edges of the image, the shape of the rotated rectangle could usefully be convolved with the shape of the largest resampling mask intended to be used when rotating to produce a slightly larger mask. Most or all of the pixels outside this slightly larger relevance mask are then treated in an appropriate manner according to the compression format being used, to attempt to reduce the size of the compressed image.

In preferred embodiments, the shape of the rotated rectangle convolved with the shape of a resampling kernel is used to construct the blanking mask to be broadly applied to capture non-rotated images prior to compression so as to reduce the size of the compressed images transmitted to the network video recorder. The shape of the resampling kernel may vary; for example without limitation, the resampling may be a 3×3 square, a 5×5 square, etc. This technique enables low complexity camera subunits to send images to network video recorders that are non-rotated and compressed yet broadly of the same size as rotated and clipped compressed images, which can be handled directly by network video recorders. Yet, these images are of broadly the same compressed size as the rotated image would be and have not been subject to the kind of resampling and filtering process typically required when rotating images. In alternate embodiments where image quality is not of particular concern, this masking process may not be performed.

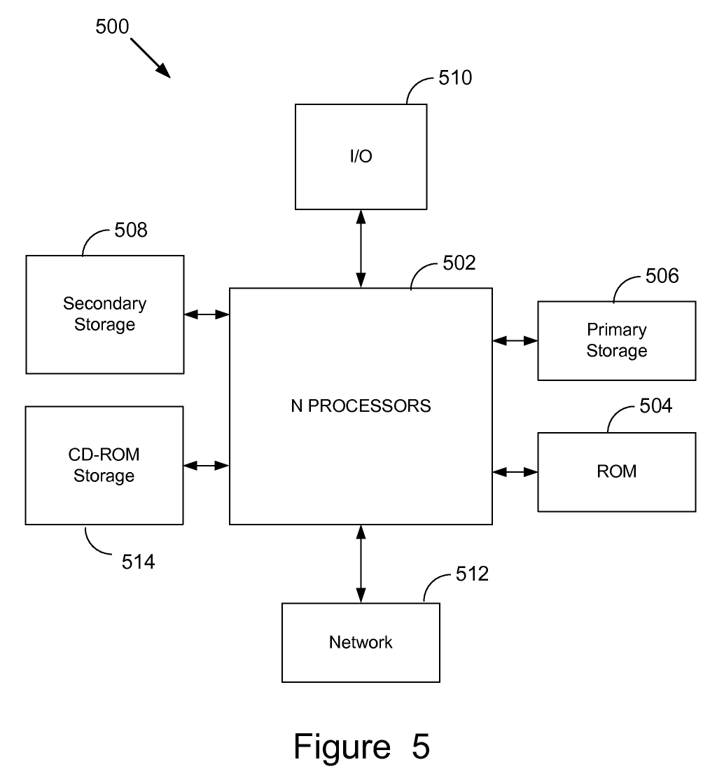

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk or a memory card. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

Having fully described at least one embodiment of the present invention, other equivalent or alternative methods of providing a camera for achieving the desirable aim of unconstrained rotation in a pan/tilt camera with an orientation mechanism of lower physical complexity than the conventional pan/tilt mechanism according to the present invention will be apparent to those skilled in the art. The invention has been described above by way of illustration, and the specific embodiments disclosed are not intended to limit the invention to the particular forms disclosed. For example, the particular implementation of the lens may vary depending upon the particular type of camera used. The lenses described in the foregoing were directed to non-zoom implementations; however, similar techniques are to provide various types of lenses such as, but not limited to, zoom lenses, wide-angle lenses, etc. For example, without limitation, in a wall-mounted camera in a room, a zoom lens may be preferable to a regular lens in order to be able to zoom in on a wall on the opposite side of the room. Implementations of the present invention using various types of lenses are contemplated as within the scope of the present invention. The invention is thus to cover all modifications, equivalents, and alternatives falling within the spirit and scope of the following claims.

What is claimed is:

1. A system for emulating a continuous pan/tilt camera, the system comprising:
means for capturing an image;
non-continuous means for orienting said capturing means to capture said image within a hemispherical space; and
means for rotating said captured image to emulate the continuous pan/tilt camera.

2. The system as recited in claim 1, wherein said means for orienting further comprises a tip/tilt orientation mechanism.

3. The system as recited in claim 1, further comprising means for adjusting said capturing means in response to a divergence between an optical center and a mechanical center of orienting means.

4. The system as recited in claim 1, further comprising means for configuring said rotating means in response to a spatial orientation of said hemispherical space.

5. The system as recited in claim 1, further comprising means for transmitting said image and rotation information to said rotating means.

6. The system as recited in claim 5, further comprising means for compressing said image before transmitting to said rotating means.

7. The system as recited in claim 6, further comprising means for reducing a size of said compressed image.

8. A system for emulating a continuous pan/tilt camera, the system comprising:
a camera comprising an image sensor for capturing an image;
a camera orientation system comprising a constrained range of movement for positioning said camera to capture said image within a hemispherical space; and
an image transformation system for rotating a portion of said captured image to emulate the continuous pan/tilt camera.

9. The system as recited in claim 8, wherein said camera orientation system further comprises a tip/tilt orientation mechanism having two axes of rotation, where said two axes of rotation are generally orthogonal to each other and generally parallel to a plane forming a back side of said hemispheric space.

10. The system as recited in claim 8, wherein said camera further comprises a control system for adjusting an active area of said image sensor in response to a divergence between an optical center of said image sensor and a mechanical center of camera orientation system.

11. The system as recited in claim 8, wherein at least said image transformation system is configurable in response to a spatial orientation of said hemispherical space.

12. The system as recited in claim 8, wherein said camera transmits said image and rotation information to said image transformation system.

13. The system as recited in claim 12, wherein said camera compresses said image before transmitting to said image transformation system.

14. The system as recited in claim 13, wherein pixels outside a desired rotated image space are processed to reduce a size of said compressed image.

15. A system for emulating a continuous pan/tilt camera, the system comprising:
a camera comprising an optical imaging system and an image sensor for capturing an image;
a camera orientation system comprising a tip/tilt orientation mechanism having two axes of rotation with constrained range of movement for positioning said camera to capture said image within a hemispherical space, wherein said two axes of rotation are generally orthogonal to each other and generally parallel to a plane forming a back side of said hemispheric space; and
an image transformation system for rotating a portion of said captured image to emulate the continuous pan/tilt camera.

16. The system as recited in claim 15, wherein said camera further comprises a control system for adjusting an active area of said image sensor in response to a divergence between an optical center of said image sensor and a mechanical center of camera orientation system.

17. The system as recited in claim 15, wherein at least said image transformation system is configurable in response to a spatial orientation of said hemispherical space.

18. The system as recited in claim 15, wherein said camera transmits said image and rotation information to said image transformation system.

19. The system as recited in claim 18, wherein said camera compresses said image before transmitting to said image transformation system.

20. The system as recited in claim 19, wherein pixels outside a desired rotated image space are processed to reduce a size of said compressed image.
